(19) United States
(12) Patent Application Publication
(10) Pub. No.: US 2004/0264199 A1
(43) Pub. Date: Dec. 30, 2004

(54) LED spotlight (type III)

(76) Inventors: Kuo-Fen Shu, Hsinchu City (TW); Chung Zon Wong, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/607,989

(22) Filed: Jun. 30, 2003

(51) Int. Cl. B60Q 1/02

(52) U.S. Cl. 362/327; 362/487

(57) ABSTRACT

The present invention relates to a LED spotlight (type III), which includes a lampshell and a light-collecting cover, wherein the cover has its bottom provided with an aperture to engage with a LED. The light-collecting cover is capable of reflecting and concentrating the light emitted from the LED to a same direction that provides an efficient spotlight. An IC board, which is a DC-DC transformed, is provided under the LED for providing a suitable input current.

### BACKGROUND OF THE INVENTION

A conventional spotlight mainly includes a shell, a tungsten bulb provided therein, and a glass cover. By use of lighting of the tungsten bulb and reflection from inner curved face of the shell, the most light can be emitted forward concentratively. The known spotlight has following drawbacks:

1. The tungsten bulb has a large volume and occupies large space in the shell. It reduces the reflective effect of lighting.

2. The tungsten bulb needs large power and leads high heat. It will be more possible to cause a fire in accident.

3. It is necessary to use an extra transformer to light the tungsten bulb.

4. The tungsten is easily broken and has a short used period.

Accordingly, the present invention is to overcome the drawback of the conventional product and to provide a LED spotlight, which uses LED and a light-collecting cover to emit light concentratively, and it can be used for a long term and low power needed.

### BRIEF DESCRIPTION OF THE DRAWINGS

The following drawings indicate the character and improvement of the present invention.

FIG. 1 shows an exploded perspective view of a LED spotlight according to the present invention.

FIG. 2 shows an assembled perspective view of FIG. 1.

FIG. 3 shows a cross-sectional plan view of FIG. 2.

FIG. 4 shows an embodiment of a circuit of IC board according to the present invention.

### DETAILED DESCRIPTION OF THE INVENTION

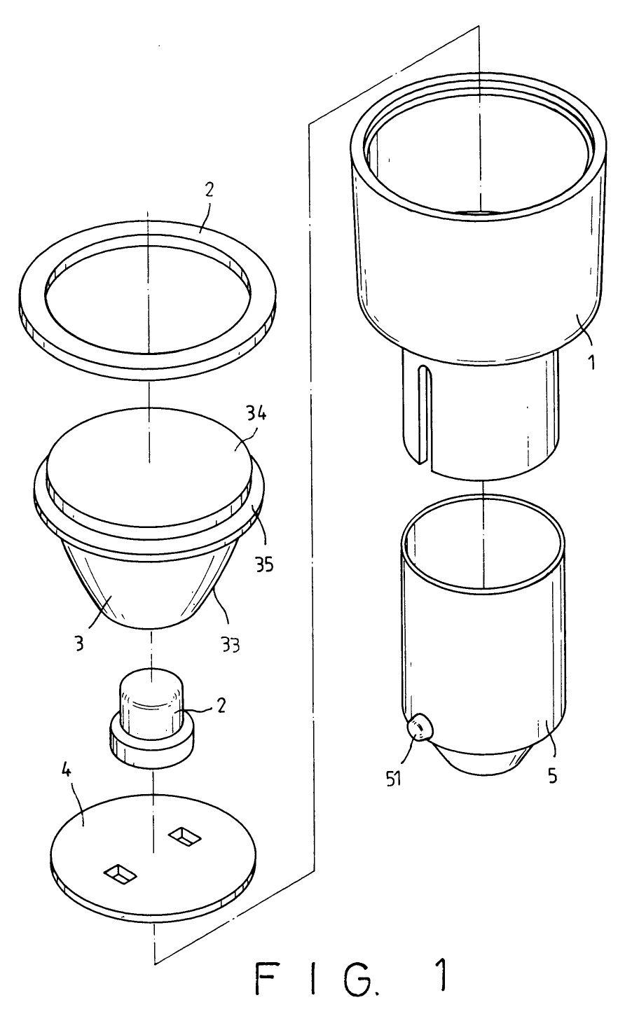

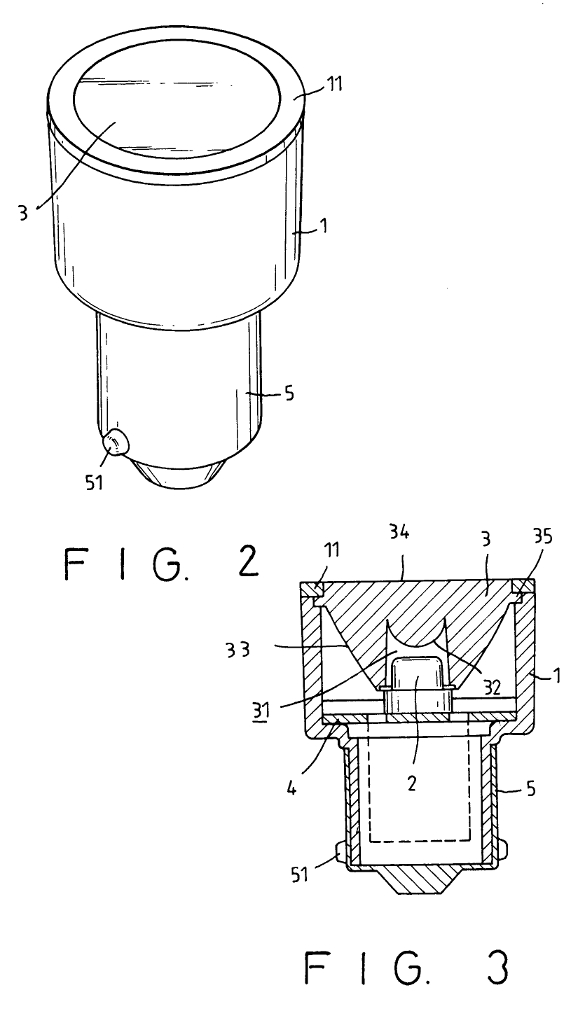

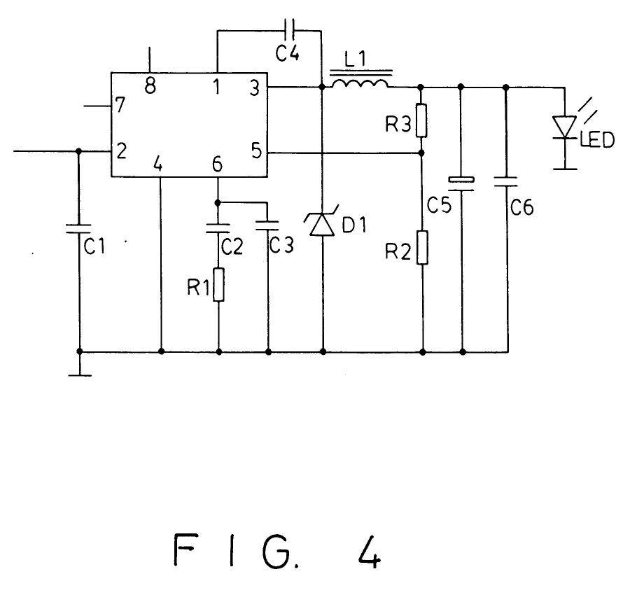

Please referring to FIG. 1 to 3, the present invention relates to an improvement of a spotlight, which includes a lampshell (1), a LED (2), and a light-collecting cover (3). The light-collecting cover (3) is a transparent solid body and has its side being a paraboloid (33). An aperture (31) is formed at bottom side of the cover (3) while a convex (32) is formed therein. Top of the cover (3) is formed a plane (34). A flange (35) is provided around the cover (3) for being placed on the shell (1) and engaged with a cap (11). The LED (2) can be received within the aperture (31). When the LED (2) is enlightened, the light can be emitted concentratively forward because of the light-collecting cover (3) and its side paraboloid (33) to reflecting the light efficiently. Hence, the LED spotlight obtains a perfect light effect.

An IC board (4) is provided under the LED (2) and a conductive shell (5) is provided outside the lower portion of the lampshell (1), wherein the electrical connection can be as shown in FIG. 4. The circuit includes the electrode (51) connecting with a DC input and uses several capacitors C1-C4, resistances R1-R3, diode D1, and inductance L1 to form a DC-DC transforming circuit, that transforms input voltage from 12V to 3V for directly use of LED. Hence, the spotlight according to the present invention can be directly applied for a car, which usually uses a 12V battery.

Accordingly, the LED has a long used period, and the use of the present invention will be secure and utilized. The light-collecting cover can provide a well effect for concentrating the light and reaches an excellent spotlight. Moreover, the spotlight of the present invention includes a special IC board accompanying with the conductive shell outside the lampshell that facilitates the directly use for LED.

What is claimed is:

1. A LED spotlight (type III) including a lampshell, a LED, and a light-collecting cover, wherein the light-collecting cover is a transparent solid body and has its side being a paraboloid, an aperture being formed at bottom side of the cover while a convex is formed therein, top of the cover being formed a plane, and a flange being provided around the cover for being placed on the lampshell and engaged with a cap; the LED can be received within the aperture, and when the LED is enlightened, the light can be emitted concentratively forward by the light-collecting cover and its side paraboloid to reflecting the light efficiently for obtaining a perfect light effect; and an IC board being provided under the LED and a conductive shell being provided outside the lower portion of the lampshell, wherein the electrical connection being that the circuit includes the electrode connecting with a DC input and includes several capacitors, resistances, diode, and inductance to form a DC-DC transforming circuit, that transforms input voltage from 12V to 3V for directly use of LED, and the spotlight can be directly applied for a car.
